(19) United States
(12) Patent Application Publication
(10) Pub. No.: US 2011/0024377 A1
(43) Pub. Date: Feb. 3, 2011

(54) OVERHEAD TRAVELLING VEHICLE

(75) Inventor: Makoto Yamamoto, Kyoto-shi (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MURATA MACHINERY, LTD., Kyoto-shi (JP)

(21) Appl. No.: 12/842,621

(22) Filed: Jul. 23, 2010

(30) Foreign Application Priority Data
Jul. 30, 2009 (JP) 2009-177390

(51) Int. Cl. B66C 1/10; B66C 19/00

(52) U.S. Cl. 212/71

(57) ABSTRACT

An overhead travelling vehicle stores and transports, through a suspended flange, a FOUP having a body, the flange provided on top of the body, and a pair of side flanges projecting laterally from side positions of the body above the bottom of the body. The overhead travelling vehicle is provided with a vehicle body, a pair of article drop preventing members, and a drive mechanism. The pair of article drop preventing members is provided at the vehicle body and is moveable between a drop preventing position under the side flanges and a receding position receding from the drop preventing position. The drive mechanism drives the article drop preventing members.

### CROSS-REFERENCE TO RELATED APPLICATIONS

This application claims priority under 35 U.S.C. §119 to Japanese Patent Application No. 2009-177390 filed on Jul. 30, 2009. The entire disclosure of Japanese Patent Application No. 2009-177390 is hereby incorporated herein by reference.

### BACKGROUND OF THE INVENTION

1. Field of the Invention

The present invention relates to an overhead travelling vehicle, particularly an overhead travelling vehicle, used for storing and transporting a suspended article, having middle projecting portions which project laterally from side positions the body of the article above the bottom of the body of the article.

2. Background Information

Conventionally, an overhead travelling vehicle system is used in a clean room of, for example, a semiconductor fabrication facility to prevent dust. In the overhead travelling vehicle system, an overhead travelling vehicle travels along a travelling rail installed on the ceiling to transport an article.

The overhead travelling vehicle includes a travelling unit for travelling along the travelling rail, a storage unit for storing an article, and a vehicle body for lifting and lowering the article. The vehicle body has a clamp for holding the article, a belt for lifting and lowering the clamp, and a belt drive mechanism for winding up and down the belt.

A FOUP (Front Opening Unified Pod) is an article that the overhead travelling vehicle may transport in a clean room. The FOUP is a sealed pod for storing a wafer. A high cleanness of wafer through a use of a FOUP may correspond to a micro semiconductor circuit associated with a large of wafer size. The FOUP has a cassette and a lid for closing an opening side of the cassette. The lid prevents particles from entering into the FOUP, and establishes a position of a wafer in the cassette.

The overhead travelling vehicle travels with the FOUP lifted by the vehicle body and stored in the storage unit. When the overhead travelling vehicle reaches the front of a semiconductor fabrication device, the vehicle body lowers and places the FOUP on a platform of a load port of the semiconductor fabrication device. After being placed, the FOUP is docked to an opening of the semiconductor fabrication device. Next, a FOUP opener removes the lid from the cassette of the FOUP, and draws the lid into the semiconductor fabrication device. Then, the wafer is carried into the semiconductor fabrication device to be processed. After being processed, the wafer is returned into the FOUP, and the opening of the FOUP is closed by the lid. After the vehicle body holds the FOUP on the platform of the load port of the semiconductor fabrication device, the overhead travelling vehicle starts to travel with the FOUP lifted and stored in the storage unit. In this way, the overhead travelling vehicle transports the FOUP from one load port to another load port.

With the overhead travelling vehicle system, an automatic guided vehicle or a worker may pass and/or work somewhere under the travelling rail. In this situation, a fall of the FOUP may injure or cause damage to the worker and/or some devices. Japanese Patent Laid-open No. 2004-277066 discloses an overhead travelling vehicle having an article drop preventing mechanism.

A conventional overhead travelling vehicle has an article drop preventing mechanism provided at lower ends of a front cover and a rear cover of the vehicle. More specifically, the article drop preventing mechanism has article drop preventing members and a drive mechanism for driving the article drop preventing members. The article drop preventing members provided at the lower ends of the front cover and the rear cover are moveable between a receding position in the covers and a drop preventing position projecting from the covers under switching control of the drive mechanism.

Accordingly, an arrangement of the article drop preventing members requires extending the lower ends of the covers downward, beyond the bottom of the FOUP, which causes an increase of the height of the overhead travelling vehicle.

An object of the present invention is to reduce the height of an overhead travelling vehicle having article drop preventing members.

### SUMMARY OF THE INVENTION

An overhead travelling vehicle in accordance with an illustrative embodiment of the present invention stores and transports an article having a body, a top projecting portion provided on top of the body, and a pair of middle projecting portions projecting laterally from side positions of the body above the bottom of the body. The top projecting portion is suspended while the article is stored and transported. The overhead travelling vehicle comprises a vehicle body unit, a pair of article drop preventing members, and a drive mechanism. The pair of article drop preventing members is provided at positions above lower ends of the vehicle body unit, and moveable between a drop preventing position under the pair of middle projecting portions and a receding position receding from the drop preventing position. The drive mechanism drives the pair of article drop preventing members.

The overhead travelling vehicle allows a reduced height thereof.

These and other objects, features, aspects and advantages of the present invention will become apparent to those skilled in the art from the following detailed description, which, taken into conjunction with the annexed drawings, discloses a preferred embodiment of the present invention.

### BRIEF DESCRIPTION OF THE DRAWINGS

FIG. 1 is a schematic diagram of an overhead travelling vehicle system in a clean room.

FIG. 2 is a partial side view of the overhead travelling vehicle system and an overhead travelling vehicle.

FIG. 3 is a longitudinal cross sectional view of the inside of a guide rail.

FIG. 4 is a block diagram showing a control configuration of the overhead travelling vehicle.

FIG. 5 is a partial side view showing the overhead travelling vehicle system and the overhead travelling vehicle.

FIG. 6 is a schematic top view showing a relationship between a FOUP and article drop preventing members.

FIG. 7 is a schematic top view showing a relationship between a FOUP and article drop preventing members.

FIG. 8 is a schematic front view showing a relationship between a FOUP and article drop preventing members.

FIG. 9 is a schematic front view showing a relationship between a FOUP and article drop preventing members.

### DETAILED DESCRIPTION OF ILLUSTRATIVE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### (1) Overhead Travelling Vehicle System

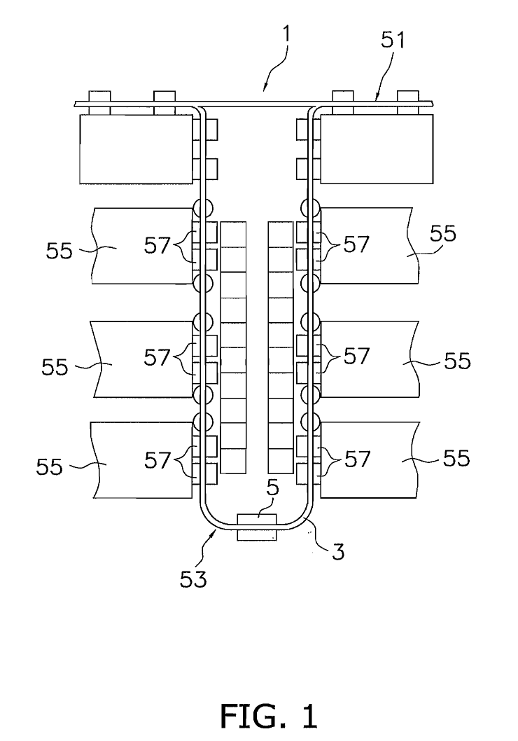

An overhead travelling vehicle system 1 will be explained referring to FIG. 1. FIG. 1 is a schematic diagram of an overhead travelling vehicle system in a clean room. The overhead travelling vehicle system 1 is provided in, for example, a clean room of a semiconductor facility. The overhead travelling vehicle system 1 transports a FOUP (Front Opening Unified Pad) 4 as will be described later. The overhead travelling vehicle system 1 comprises mainly a guide rail 3 and an overhead travelling vehicle 5 travelling along the guide rail 3.

A semiconductor facility will be explained. The semiconductor facility has a plurality of bays and an inter-bay route 51 for connecting one bay to another bay. Each bay has an intra-bay route 53. The inter-bay route 51 and the intra-bay routes 53 constitute the guide rail 3.

A plurality of processing devices 55, such as semiconductor processing devices, are arranged along the intra-bay route 53. Further, a load port 57 is arranged adjacent to each of the processing devices 55. The load port 57 is arranged just under the intra-bay route 53. In this configuration, the overhead travelling vehicle 5 travels along the guide rail 3 to transport a FOUP 4 from one load port 57 to another load port 57, as will be described later.

### (2) Guide Rail

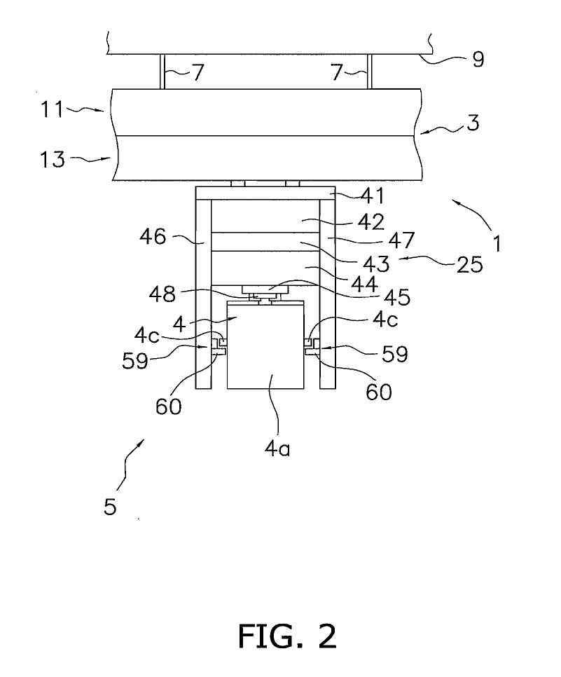

The guide rail 3 will be explained referring to FIG. 2. FIG. 2 is a partial side view of the overhead travelling vehicle system and the overhead travelling vehicle. The guide rail 3 is suspended by a plurality of columns 7 from a ceiling 9. The guide rail 3 mainly has a travelling rail 11 and a power feed rail 13 provided under the travelling rail 11.

(2-1) Travelling Rail

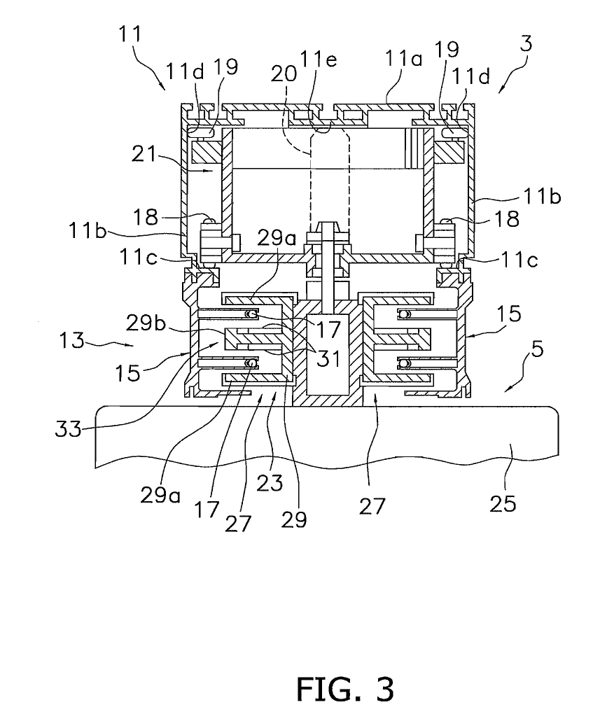

The travelling rail 11 will be explained referring to FIG. 3. The travelling rail 11 is, for example, an aluminum rail. As seen in the cross section of FIG. 3, a travelling rail 11 is formed in an inverted U shape, including an upper face 11a and two side faces 11b. A pair of first travelling surfaces 11c extends inward from the lower parts of the side faces 11b. Further, a pair of second travelling surfaces 11d is provided on the upper and inner side of the side faces 11b. A third travelling surface 11e is provided on the underside of the upper face 11a.

(2-2) Power Feed Rail

The power feed rail 13 mainly comprises a pair of feed holders 15 provided under the respective side faces of the travelling rail 11. Each of the feed holders 15 holds a pair of power feed cables 17 which are composed of Litz wires having conductive wires such as copper wires covered with insulating materials. A power feed device (not shown) connected to one end of the power feed cables 17 supplies high-frequency electric current to the power feed cables 17.

### (3) Overhead Travelling Vehicle

The overhead travelling vehicle 5 mainly comprises a travelling unit 21, a power receiving unit 23, and a vehicle body 25. The travelling unit 21 is arranged within the travelling rail 11 so as to travel along the guide rail 3. The power receiving unit 23 is arranged within the power feed rail 13 so that electrical power from the power feed cables 17 is supplied. The vehicle body 25 is arranged under the power feed rail 13 so as to hold, lift and lower the FOUP 4.

(3-1) Travelling Unit

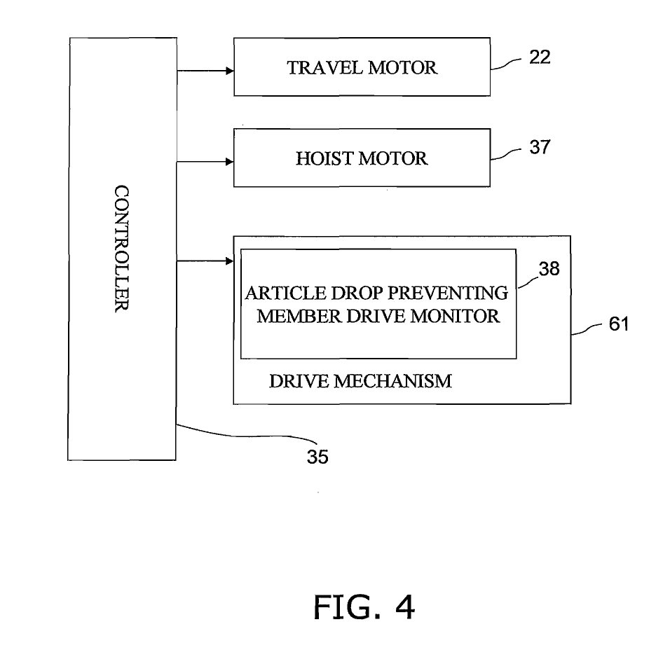

The travelling unit 21 is arranged within the travelling rail 11. The travelling unit 21 mainly comprises a pair of first guide wheels 18, a pair of second guide wheels 19, a travelling drive wheel 20, and a travel motor 22 (referring to FIG. 4). The pair of first guide wheels 18 is arranged on the lower parts of the two sides of the travelling unit 21. The pair of first guide wheels 18 is rotatably supported by wheel axles that extend transversely i.e. along the left-right direction with respect to the direction of travel. The first guide wheels 18 are located on the first travelling surfaces 11c of the travelling rail 11.

The second guide wheels 19 are provided on the upper parts of the two sides of the travelling unit 21. The second guide wheels 19 are supported rotatably by wheel axles that extend vertically. The second guide wheels 19 prevent lateral misalignment of the travelling unit 21, with the second travelling surfaces 11d of the travelling rail 11 as guide surfaces.

The travelling drive wheel 20 is arranged substantially at the center of the travelling unit 21. The travelling drive wheel 20 is pressed against the third travelling surface 11e of the travelling rail 11 through pressure means such as a spring. The travel motor 22 drives the travelling drive wheel 20. This configuration allows the overhead travelling vehicle 5 to travel along the travelling rail 11.

(3-2) Power Receiving Unit

The power receiving unit 23 has a pair of pick-up units 27 for receiving electrical power from the power feed cables 17. Specifically, the pair of pick-up units 27 is arranged transversely side by side within the power feed rail 13. Each of the pick-up units 27 has a ferrite core 29, whose cross section is substantially E-shaped, and a pick-up coil 31 winding around the core 29. Specifically, the core 29 has two side projections 29a and a center projection 29b between the two side projections 29a. The pick-up coil 31 winds around the center projection 29b.

The power feed cables 17 held by the feed holders 15 are arranged between the side projections 29a and the center projection 29b. A high-frequency electric current in the power feed cables 17 generates a magnetic field which causes the pick-up coil 31 to generate induced current. Thus, contactless power supply from the power feed cables 17 to the pick-up unit 27 drives the travel motor 22 and supplies power to a control instrument. As explained above, a contactless power feeder 33 comprises a pair of power feed cables 17 in the power feed rail 13 and the power receiving unit 23 of the overhead travelling vehicle 5.

(3-3) Vehicle Body

The vehicle body 25 will be explained referring to FIG. 2. As shown in FIG. 2, the vehicle body 25 mainly comprises a body frame 41, a lateral move unit 42, a θ drive 43, a hoist body 44, and a lifter 45.

The body frame 41 is fixed under the bottom of the power receiving unit 23. A front side cover 46 and a rear side cover 47 are provided respectively at the front side and the rear side of the body frame 41, with respect to the direction of travel of the vehicle body 25.

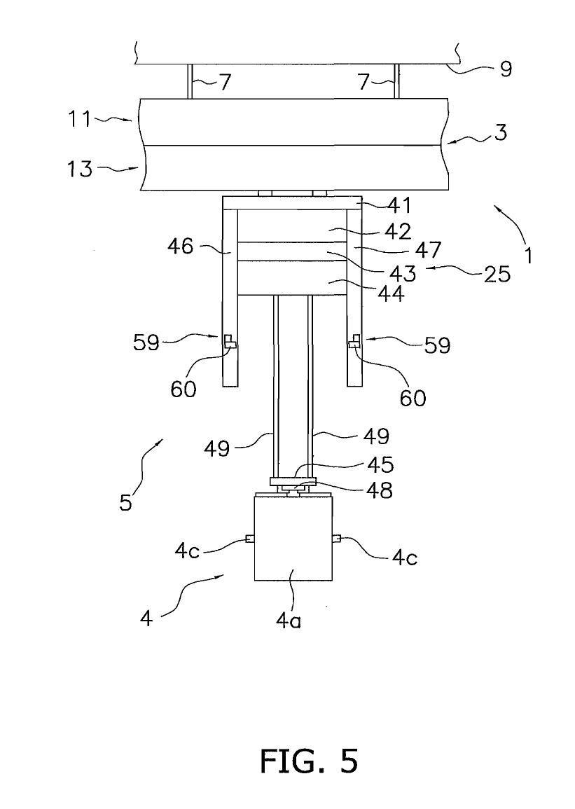

The lateral move unit 42, for example, moves the θ drive 43, the hoist body 44 and the lifter 45 laterally and allows transport of the FOUP 4 from and to a side buffer (not shown) which is arranged laterally to the guide rail 3. The θ drive 43 rotates the hoist body 44 horizontally to facilitate transport of the FOUP 4. The hoist body 44 has elevation means (not shown) for lifting and lowering the lifter 45. The elevation means has, for example, four pairs of wind-up drums and a hoist motor 37 (shown in FIG. 4) for driving the wind-up drums. A belt 49 is hung around the wind-up drums (shown in FIG. 5). The ends of the belt 49 are attached to the lifter 45.

Each of the front side cover 46 and the rear side cover 47 has a housing which includes an open space to store an article drop preventing mechanism 59 therein, as will be explained below.

The lower ends of the front side cover 46 and the rear side cover 47 are positioned below or at the same level as the bottom of a body of the FOUP 4, so that the lower end of the overhead travelling vehicle 5 is positioned adjacent to the bottom of the FOUP 4.

### (4) FOUP

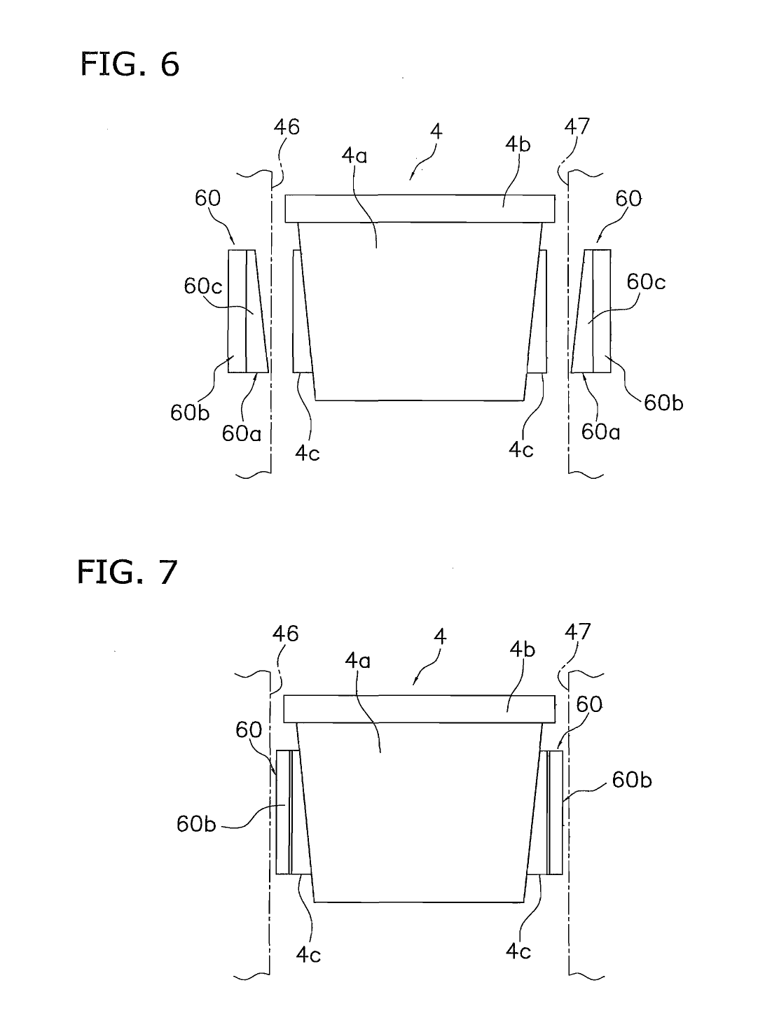

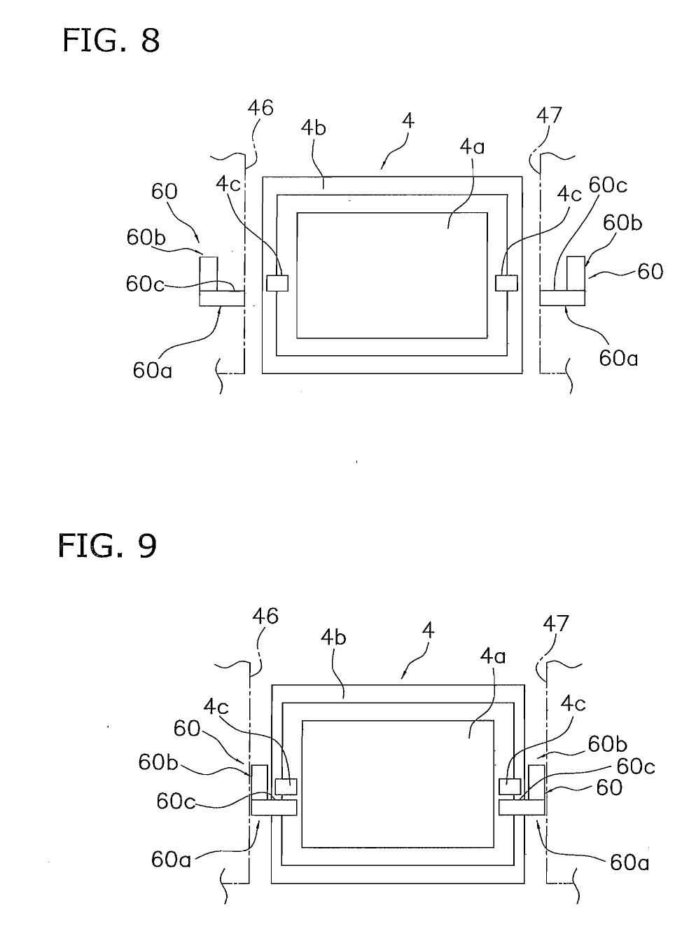

The FOUP 4 will be explained referring to FIGS. 6-9. FIGS. 6-7 are schematic top views showing a relationship between the FOUP and article drop preventing members. FIGS. 8-9 are schematic front views showing a relationship between the FOUP and article drop preventing members. Hereinafter, a direction along the direction of travel of the vehicle body 25 is referred to as a front-rear direction. A direction perpendicular to the direction of travel of the vehicle body 25 is referred to as a left-right direction which is a vertical direction shown in FIGS. 6-7.

The FOUP 4 has a body 4a and a lid 4b. The body 4a stores a plurality of semiconductor wafers therein. The lid 4b is attached to one side of the body 4a and can be opened and closed. A flange 48 (shown in FIG. 2) is arranged on the top of the FOUP 4. The flange 48 is clamped by the lifter 45.

A pair of side flanges 4c are provided on the front side face and the back side face of the body 4a respectively, each of which projects from either side face of the body 4a. Each of the side flanges 4c has an elongated shape, and is provided on the middle area between the top and the bottom of the body 4a along either side face.

As stressed in FIGS. 6-7, a width between the front side face and the back side face of the body 4a becomes narrower as it gets further from the lid 4b, so that in the front-rear direction, a length of the side of the body 4a close to the lid 4b is longer than that of the opposite side. Such a slope is formed when the FOUP 4 is unmolded.

Each of the side flanges 4c is formed such that its width becomes wider as the width of the body 4a becomes narrower. This configuration allows the front side and the back side of the side flanges 4c to be parallel to the left-right direction. Further, the front side and the back side of the side flanges 4c are positioned within both ends of the lid 4b with respect to the front-rear direction.

This increases the surface area of the side flanges 4c without increasing surface area which projects from the body 4a.

### (5) Article Drop Preventing Mechanism

Next, an article drop preventing mechanism 59 will be explained. The article drop preventing mechanism 59 comprises article drop preventing members 60 and a drive mechanism 61 for moving the article drop preventing members 60 between a drop preventing position and a receding position.

As shown in FIGS. 2 and 5, the article drop preventing members 60 are arranged above the lower ends of the front side cover 46 and the rear side cover 47 so as to prevent the FOUP 4 from dropping. In FIG. 2, the FOUP 4 is located in a stored position, and the article drop preventing members 60 are positioned at a drop preventing position under the pair of side flanges 4c. In FIG. 5, the FOUP 4 is moved downward from the stored position by the hoist body 44, and the article drop preventing members 60 are positioned at a receding position, which is a position in which the article drop preventing members 60 recede away from the side flanges 4c of the FOUP 4.

Next, the drive mechanism 61 will be explained. The drive mechanism 61 mainly comprises an article drop preventing member drive motor 38 (shown in FIG. 4), a gear, a link member, and the like. An explanation of a mechanism for driving a member to travel straight or to rotate is omitted here since such a mechanism is well-known.

As shown in FIGS. 6 to 9, each of the article drop preventing members 60 comprises a first support unit 60a and a second support unit 60b. The first support units 60a are arranged so as to move under the side flanges 4c. The first support units 60a include support faces 60c with shapes corresponding to the side flanges 4c. In other words, each of the support faces 60c of the first support units 60a has a shape elongated in the left-right direction. While the side ends of the support faces 60c further from the FOUP 4 are parallel to the left-right direction, the other side ends closer to the FOUP 4 are inclined with respect to the left-right direction and are parallel to the side faces of the body 4a of the FOUP 4. Each of the second support units 60b is arranged on the top surface of a first support unit 60a, at an end further from the body 4a. The second support units 60b have side faces parallel to the left-right direction.

### (6) Control Configuration

A control structure of the overhead travelling vehicle 5 will be explained referring to FIG. 4. FIG. 4 is a block diagram showing a control configuration of an overhead travelling vehicle.

As shown in FIG. 4, the overhead travelling vehicle 5 comprises a controller 35. The controller 35 has a CPU, a RAM, a ROM and the like to execute a program. The controller 35 may communicate with a host controller. The controller 35 has a route map in a memory so that the overhead travelling vehicle 5 may travel continuously, while comparing a coordinate plotted on the route map to an internal coordinate calculated by an encoder of the overhead travelling vehicle 5. The controller 35 may transmit an activating instruction to the travel motor 22, the hoist motor 37, the article drop preventing member drive motor 38, and other mechanisms.

### (7) Movement

(7-1) Movement in Transporting an Article

As shown in FIG. 2, when the overhead travelling vehicle 5 transports the FOUP 4, the drive mechanism 61 of the article drop preventing mechanism 59 moves the article drop preventing members 60 to the drop preventing position, so that as shown in FIGS. 7 and 9, the first support units 60a of the article drop preventing members 60 are positioned under the side flanges 4c. This placement prevents the FOUP 4 from dropping. It should be noticed that, in this situation, there are gaps between the support faces 60c of the article drop preventing members 60 and the bottoms of the side flanges 4c.

There are also gaps between side faces of the article drop preventing members 60 and the front and back sides of the side flanges 4c. Reducing or eliminating the gaps may provide low vibration of the FOUP 4 while the overhead travelling vehicle 5 is travelling.

The overhead travelling vehicle 5 has the article drop preventing members 60 with the shapes corresponding to the shapes of the side flanges 4c of the FOUP 4, which provides large area of the article drop preventing members 60 for supporting the side flanges 4c. As a result, the article drop preventing members 60 provide a stable support for the FOUP 4.

The overhead travelling vehicle 5 has the article drop preventing members 60 arranged above the lower ends of the overhead travelling vehicle 5 and below the side flanges 4c of the FOUP 4, so that no arrangement of the article drop preventing members 60 at the lower ends of the vehicle body 25 of the overhead travelling vehicle 5 is necessary. Therefore, no space for the article drop preventing members 60 at the lower ends of the overhead travelling vehicle 5 is required. As a result, a vertical length of the vehicle body 25 may decrease, so that a height of the overhead travelling vehicle 5 may be reduced.

(7-2) Movement in Lifting or Lowering an Article

As shown in FIG. 5, when the overhead travelling vehicle 5 stops so as to lift or lower the FOUP 4, the drive mechanism 61 of the article drop preventing mechanism 59 moves the article drop preventing members 60 to the receding position. More specifically, as shown in FIGS. 6 and 8, the first support units 60a of the article drop preventing members 60 are not positioned under the side flanges 4c, so that the article drop preventing members 60 do not interfere with the FOUP 4.

### (8) Features

The overhead travelling vehicle 5 stores and transports, through the suspended flange 48, the FOUP 4 having the body 4a, the flange 48 provided on top of the body 4a, and the pair of side flanges 4c projecting laterally from side positions of the body 4a above the bottom of the body 4a. The overhead travelling vehicle 5 comprises the vehicle body 25, the pair of article drop preventing members 60, and the drive mechanism 61. The pair of article drop preventing members 60 is provided at positions above lower ends of the vehicle body 25 and is moveable between the drop preventing position and the receding position receding from the drop preventing position. The drive mechanism 61 drives the pair of article drop preventing members 60.

The overhead travelling vehicle 5 has the article drop preventing members 60 arranged above the lower ends of the vehicle body 25 so that the article drop preventing members 60 may be positioned under the side flanges 4c of the FOUP 4. Therefore, no arrangement of the article drop preventing members 60 at the lower ends of the vehicle body 25 is necessary. Accordingly, no space for the article drop preventing members 60 at the lower ends of the vehicle body 25 of the overhead travelling vehicle 5 is required. As a result, a vertical length of the vehicle body 25 may decrease, so that a height of the overhead travelling vehicle 5 may be reduced.

The vehicle body 25 includes the front side cover 46 and the rear side cover 47 respectively arranged at a front and a rear side of the vehicle body 25, with respect to the direction of travel. The lower ends of the front side cover 46 and the rear side cover 47 are positioned below or at the same level as the bottom of the body 4a of the FOUP 4. The pair of article drop preventing members 60 is provided above the lower ends of the front side cover 46 and the rear side cover 47.

In this overhead travelling vehicle 5, the lower ends of the front side cover 46 and the rear side cover 47 are positioned below or at the same level as the bottom of the body 4a, so that the lower ends of the overhead travelling vehicle 5 are positioned adjacent to the bottom of the FOUP 4. As a result, a height of the overhead travelling vehicle 5 may be reduced.

The pair of article drop preventing members 60 has the pair of first support units 60a movably provided to locate under the pair of side flanges 4c when the FOUP 4 is stored in the vehicle body 25. The pair of first support units 60a has a shape capable of supporting the pair of side flanges 4c.

The pair of side flanges 4c are provided respectively on a front side and a back side of the body 4a of the FOUP 4. The front and the back sides are inclined with respect to the direction of travel of the overhead travelling vehicle 5, so that the width between the front side and the back side varies in a planar view. The pair of first support units 60a has respective sides thereof formed along the front side and the back side.

The pair of first support units 60a has substantially the same shape as the pair of side flanges 4c.

In the overhead travelling vehicle 5, the pair of article drop preventing members 60 has the pair of first support units 60a with the shape corresponding to the shape of the pair of side flanges 4c of the FOUP 4, which provides large area of the pair of first support units 60a for supporting the side flanges 4c. As a result, the article drop preventing members 60 provide a stable support for the FOUP 4.

### (9) Other Embodiments

While one embodiment of the present invention has been explained, the present invention is by no means limited to the above embodiment, and various changes can be made without departing from the scope of the present invention.

(A) In the above embodiment, the travelling vehicle system provided in a clean room of a semiconductor facility is explained, but the present invention is not limited to the embodiment. For example, the present invention is applicable to other kinds of facilities.

(B) An article to be transported is the FOUP in the above embodiment, but the present invention is not limited to the embodiment. The present invention is applicable to an overhead travelling vehicle for transporting other articles.

(C) In the above embodiment, the shape of the support faces of the first support units of the article drop preventing members substantially corresponds to that of the side flanges, but the present invention is not limited to the embodiment. For example, the support faces of the first support units of the article drop preventing members may have any shape capable of supporting effectively the side flanges.

(D) In the above embodiment, there are gaps between the inner sides of the second support units of the article drop preventing members and the side ends of the side flanges, but the present invention is not limited to the embodiment. For example, the inner sides of the seconds support units of the article drop preventing members may be purposely in contact with the sides of the side flanges in order to prevent vibration.

(E) An elastic member may be provided on the article drop preventing members so as to absorb shock to an article and thereby enhance the vibration prevention effect.

(F) In the above embodiment, the side flanges of the FOUP are provided on the middle area between the top and the bottom of the body, but the present invention is not limited to the embodiment. The side flanges of the FOUP may be arranged immediately above the bottom of the body of the FOUP.

(G) In the above embodiment, the article drop preventing members have the shapes which correspond to those of the side flanges of the FOUP. However, a link mechanism and the like for changing shapes of the article drop preventing members may allow shapes of the article drop preventing members to fit those of the side flanges of the FOUP when moving towards the drop preventing position.

The present invention is widely applicable to an overhead travelling vehicle for storing and transporting a suspended article having a pair of middle projecting portions projecting laterally from side positions of a body unit above the lower end of the body unit.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An overhead travelling vehicle for storing and transporting a article having a body, a top projecting portion provided on top of the body, and a pair of middle projecting portions projecting laterally from side positions of the body above the bottom of the body, the top projecting portion being suspended while the article is being stored and transported, comprising:
a vehicle body unit;
a pair of article drop preventing members provided at positions above lower ends of the vehicle body unit and moveable between a drop preventing position under the pair of middle projecting portions and a receding position receding from the drop preventing position; and
a drive mechanism for driving the pair of article drop preventing members.

2. The overhead travelling vehicle according to claim 1, wherein:
the vehicle body unit includes a first cover and a second cover respectively arranged at a front and a rear side of the vehicle body unit with respect to the direction of travel, the first cover and the second cover having lower ends;
the lower ends of the first cover and the second cover are positioned below or at the same level as the bottom of the body of the article; and
the pair of article drop preventing members are provided above the lower ends of the first cover and the second cover.

3. The overhead travelling vehicle according to claim 1, wherein:
the pair of article drop preventing members have a pair of support units movably provided under the pair of middle projecting portions when the article is stored in the vehicle body unit; and
the pair of support units has a shape capable of supporting the pair of middle projecting portions.

4. The overhead travelling vehicle according to claim 2, wherein:
the pair of article drop preventing members have a pair of support units movably provided under the pair of middle projecting portions when the article is stored in the vehicle body unit; and
the pair of support units has a shape capable of supporting the pair of middle projecting portions.

5. The overhead travelling vehicle according to claim 3, wherein:
the pair of middle projecting portions are provided respectively on a first and a second side of the body of the article, the first side and the second side being inclined with respect to the direction of travel so that a width between the first side and the second side varies in a planar view; and
the pair of support units has respective sides formed along the first side and the second side.

6. The overhead travelling vehicle according to claim 4, wherein:
the pair of middle projecting portions are provided respectively on a first and a second side of the body of the article, the first side and the second side being inclined with respect to the direction of travel so that a width between the first side and the second side varies in a planar view; and
the pair of support units has respective sides formed along the first side and the second side.

7. The overhead travelling vehicle according to claim 5, wherein the pair of support units has substantially the same shape as the pair of middle projecting portions.

8. The overhead travelling vehicle according to claim 6, wherein the pair of support units has substantially the same shape as the pair of middle projecting portions.
